(19) United States
(12) Patent Application Publication
(10) Pub. No.: US 2015/0113123 A1
(43) Pub. Date: Apr. 23, 2015

(54) METHOD AND APPARATUS FOR PERFORMING NETWORK DISCOVERY

(71) Applicant: TELEFONAKTIEBOLAGET L M ERICSSON (PUBL), Stockholm (SE)

(72) Inventors: Shing Yeung, Burnaby (CA); Kelvin Ting, Coquitlam (CA); Chris Stein, Langley (CA); Chirag Rajyaguru, Fremont, CA (US)

(73) Assignee: TELEFONAKTIEBOLAGET L M ERICSSON (PUBL), Stockholm (SE)

(21) Appl. No.: 14/060,356

(22) Filed: Oct. 22, 2013

(51) Int. Cl. H04L 12/26

(52) U.S. Cl. CPC H04L 43/04
USPC 709/224

(57) ABSTRACT

Disclosed is a method and server for discovering virtual private networks with extranet configurations. An extent of a virtual private network (VPN) is determined based on matching criteria. Confirmed layer three (L3) VPNs are determined based on an enablement of a heuristic. The confirmed L3 VPNs are re-examined to determine extranet linkages.

Also disclosed is a method and user interface device for discovering VPNs with extranet configurations. VPNs whose extents cannot be reliably determined by a heuristic are manually determined using a user interface device. Extranet linkages are manually located using the user interface device.

### FIELD

The present disclosure relates to network discovery. More particularly, the present disclosure relates to virtual private network discovery.

### BACKGROUND

A Layer 3 (L3) virtual private network (VPN) is created for each different customer of a service provider. VPN and traffic separation is achieved by preventing a VPN's routes from being distributed to another customer's VPN, and vice versa.

An “extranet” is the explicit additional configuration of a VPN so the VPN has access to the routes of another VPN. These routes provide access to resources (databases, applications, others) that are explicitly designated as shared. The computer systems of the VPNs granted this access are said to participate in an extranet.

L3 VPN Service Discovery is a Network Management System (NMS) process to retrieve the VPNs' configuration from applicable network elements (NEs), and to extrapolate and create from them the correct individual VPN representations at the NMS. After they are discovered, the VPNs can be viewed, modified, and monitored at the NMS instead of at the NEs' craft terminal.

A problem occurs at the NMS (Network Management System) with respect to the correct discovery of different customer VPNs where extranets are configured among the customer VPNs. If not handled properly, the NMS will discover all VPNs interconnected via extranet linkages as one VPN instead. Because a VPN can participate in multiple extranets with other VPNs, and these other VPNs can, in turn, participate in extranets with further VPNs, what can result is a discovery problem that is difficult to solve in the general case.

Another problem is that present systems implementing a discovery method may not handle extranets linking otherwise separate customers' L3 VPNs during the L3 VPN discovery process, leading to incorrect VPN determination at the NMS.

Another problem is that present systems do not accommodate an optional need for human intervention in the final determination of L3 VPNs' extents where extranets exist among them.

Using per-service specific MPLS labels set can contribute to customer VPN separation in the data plane. However, these data plane techniques do not solve the problem of L3 VPN discovery in the control plane.

Thus, a need exists to overcome the problems with the prior art systems, designs, and processes as discussed above.

### SUMMARY

Disclosed is a method for discovering virtual private networks with extranet configurations. In one embodiment, an extent of a virtual private network (VPN) is determined based on matching criteria. Confirmed layer three (L3) VPNs are determined based on an enablement of a heuristic. The confirmed L3 VPNs are re-examined to determine extranet linkages.

Disclosed is a server for discovering virtual private networks with extranet configurations. The server includes a processor. The processor can be configured to: determine an extent of a virtual private network (VPN) based on matching criteria; determine confirmed layer three (L3) VPNs based on an enablement of a heuristic; and re-examine the confirmed L3 VPNs to determine extranet linkages.

Extranet linkages can be determined automatically when a heuristic is enabled and used. The L3 VPNs or extranet linkages may be further confirmed using a second heuristic that is based on formatting. The L3 VPNs or extranet linkages can be further confirmed using a second heuristic that is based on a naming convention.

Layer 3 VPNs can be determined manually through a user interface when a heuristic is not enabled. Extranet linkages can be determined manually through a user interface when a heuristic is not enabled.

The matching criteria can be route target information. The matching criteria can be route distinguisher information. The matching criteria can also be virtual routing and forwarding (VRF) table information.

Disclosed is a method for discovering virtual private networks (VPNs) with extranet configurations. In one embodiment, VPNs whose extents cannot be reliably determined by a heuristic are manually determined using a user interface device. Extranet linkages are manually located using the user interface device.

Route target (RT), route distinguisher (RD), and virtual routing and forwarding (VRF) table name can be listed in sortable columns. Sorting on at least one of RT, RD and VRF table name allows a user of the user interface device to visually co-locate proposed VPN segments as sequential rows. Extranet linkages can be confirmed when RTs are visually co-located. Extranet linkages can be further confirmed using service provider network configuration logs or history records.

Disclosed is a user interface device for discovering virtual private networks (VPNs) with extranet configurations. The user interface device has a processor. The processor can be configured to allow a user of the user interface device to: manually determine VPNs whose extents cannot be reliably determined by a heuristic; and manually locating extranet linkages.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one. Further, when a particular feature, structure, or characteristic is described in connection with an embodiment, it is submitted that it is within the knowledge of one skilled in the art to affect such feature, structure, or characteristic in connection with other embodiments whether or not explicitly described.

FIG. 1 illustrates a block diagram of a system for implementing discovery methods, according to one embodiment.

FIG. 2 illustrates a block diagram of a method for performing network discovery, according to one embodiment.

FIG. 3 illustrates a method for discovering virtual private networks with extranet configurations, according to one embodiment.

FIG. 4 illustrates a block diagram of a method for performing service discovery, according to one embodiment.

FIG. 5 illustrates a block diagram of a method for performing service discovery, according to one embodiment.

FIG. 6 illustrates a one route distinguisher per VPN scenario according to one embodiment.

FIG. 7 illustrates a one route distinguisher per provider edge scenario according to one embodiment.

FIG. 8 illustrates a multiple route distinguisher per service scenario according to one embodiment.

FIG. 9 illustrates a full mesh scenario according to one embodiment.

FIG. 10 illustrates a hub and spoke scenario according to one embodiment.

FIG. 11 illustrates an extranet scenario according to one embodiment.

FIG. 12 illustrates an extranet scenario according to one embodiment.

FIG. 13 illustrates a diagram of a method for performing service discovery using a second pass, according to one embodiment.

FIG. 14 illustrates an example service, according to one embodiment.

FIG. 15 illustrates an example service according to one embodiment.

FIG. 16 illustrates a table implemented on a UI apparatus, according to one embodiment.

FIG. 17 a method for manually discovering VPNs with extranet configurations.

FIG. 18 illustrates a block diagram of an exemplary computer system according to one embodiment.

### DESCRIPTION OF EMBODIMENTS

In the following description, numerous specific details are set forth. However, it is understood that embodiments of the invention may be practiced without these specific details. In other instances, well-known circuits, structures and techniques have not been shown in detail in order not to obscure the understanding of this description. It will be appreciated, however, by one skilled in the art that the invention may be practiced without such specific details. Those of ordinary skill in the art, with the included descriptions, will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

As used herein, a network element (e.g., a router, switch, bridge) is a piece of networking equipment, including hardware and software that communicatively interconnects other equipment on the network (e.g., other network elements, end stations). Some network elements are “multiple services network elements” that provide support for multiple networking functions (e.g., routing, bridging, switching, Layer 2 aggregation, session border control, Quality of Service, and/or subscriber management), and/or provide support for multiple application services (e.g., data, voice, and video). Subscriber end stations (e.g., servers, workstations, laptops, netbooks, palm tops, mobile phones, smartphones, multimedia phones, Voice Over Internet Protocol (VOIP) phones, user equipment, terminals, portable media players, tablets, GPS units, gaming systems, set-top boxes) access content/services provided over the Internet and/or content/services provided on virtual private networks (VPNs) overlaid on (e.g., tunneled through) the Internet. The content and/or services are typically provided by one or more end stations (e.g., server end stations) belonging to a service or content provider or end stations participating in a peer to peer service, and may include, for example, public webpages (e.g., free content, store fronts, search services), private webpages (e.g., username/password accessed webpages providing email services), and/or corporate networks over VPNs. Typically, subscriber end stations are coupled (e.g., through customer premise equipment coupled to an access network (wired or wirelessly)) to edge network elements, which are coupled (e.g., through one or more core network elements) to other edge network elements, which are coupled to other end stations (e.g., server end stations).

Different embodiments of the invention may be implemented using different combinations of software, firmware, and/or hardware. Thus, the techniques shown in the figures can be implemented using code and data stored and executed on one or more electronic devices (e.g., an end station, a network element). Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable transmission media (e.g., electrical, optical, acoustical or other form of propagated signals—such as carrier waves, infrared signals, digital signals). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). Thus, the storage device of a given electronic device typically stores code and/or data for execution on the set of one or more processors of that electronic device.

The present disclosure solves the problem of correct L3 VPN discovery by a NMS where extranets are configured among independent L3 VPNs. The present disclosure addresses route separation/distribution in the control plane. The key configuration attribute of a L3 VPN is the route target (RT). Each VPN is assigned one or more RTs that are unique to it. The VPN is realized as a set of collaborating configurations on network elements that collectively reference the same RT set. This RT closure can be used to determine a VPN's extents objectively. Independent VPNs will have distinct RT-closures. A VPN may be defined with more than one RT-closure. Each closure represents one segment of the overall VPN.

In the extranet scenario, additional RTs are configured that result in the reduction of RT-closures determined, if the presently disclosed methods are not utilized. This will lead to the erroneous determination of fewer VPNs than the number actually configured on the NEs.

The present disclosure address the problem with an N-pass discovery method where the first pass determines the VPNs' extents, i.e. based on heuristic-qualified RT-closure, or another criteria. Then, with the individual VPNs extents tentatively known, a subsequent pass determines the extranet linkages.

Additional value-add processing steps, e.g., additional passes, may be added. Each pass builds upon the value/knowledge deposited by the previous one. These additional passes provide increased accuracy and reliability of the VPNs and extranet linkages that are determined.

The discovered VPNs, along with a view of their constituents, can be proposed to a human for confirmation via a user interface (UI) apparatus. Optionally, the discovered VPNs may be auto-confirmed with a system-defined, or a user-defined policy. This UI apparatus will provide the ability for the human to sort/organize/redisplay effectively the information presented so as to confirm, correct, or to detect erroneous RT-closure/VPN segments and their memberships in a proposed VPN.

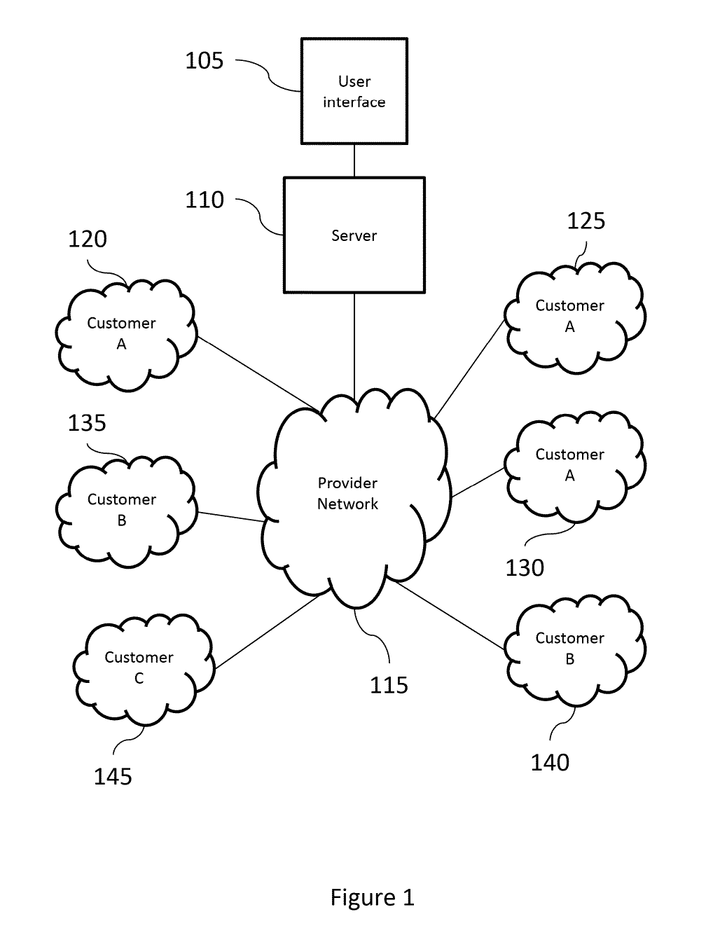

FIG. 1 illustrates a block diagram of a system for implementing discovery methods of the present disclosure, according to one embodiment. One or more provider edge (PE) routers (not shown) of a provider network 115 are coupled to a plurality of customer networks 120, 125, 130, 135, 140, 145 through a respective customer edge (CE) router (not shown) of each VPN. A server 110 implementing the discovery method of the present disclosure determines an extent of each customer's VPN, including extranet linkages. In this example, an extent of Customer A's VPN includes networks 120, 125, 130. An extent of Customer B's VPN includes networks 135, 140. Customer C's VPN includes network 145. In one embodiment, a human can confirm any discovered VPNs using user interface (UI) 105.

The system for implementing the network discovery methods of the present disclosure has the server 110 that implements a discovery method and a UI station 105 that a human interacts with to trigger the discovery function and to interact with its results. The results are discovered L3 VPN service and/or VPN segments.

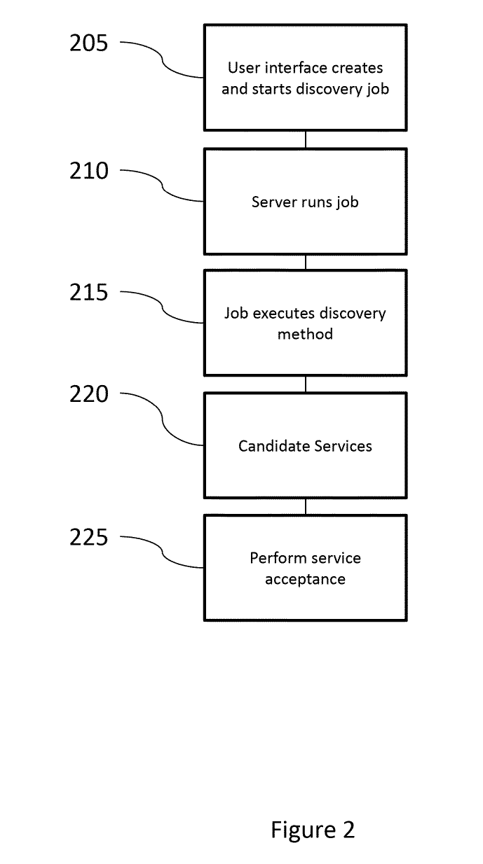

FIG. 2 illustrates a block diagram of a method for performing network discovery, according to one embodiment. At block 205, a user at a UI creates and starts a discovery job on the server, e.g., server 110. The user selects the NEs from which to discover VPN services. An indication to start the discovery job is sent from the UI to the server. At block 210, the server runs the discovery job. At block 215, the discovery job executes the discovery method. At block 220, the server returns a list of candidate services to the user interface.

At block 225, service acceptance is performed. The discovery job completes a number of candidate L3 VPN services. At this state, the services are not managed by the system. At this point, the system does not have the ability to deactivate, modify, or delete the services. Service acceptance is an explicit workflow that gives the user the ability to initiate management of the services going forward using the management system. Candidate services proposed by the discovery job, once accepted into the system, are further managed L3 VPN services, with a number of management features and functions provided, e.g., fault monitoring, synchronization with the network, activation, deactivation, diagnostics. None of the aforementioned features/functions is available prior to service acceptance. In one embodiment, candidate services can be set by policy to be auto-accepted without explicit human intervention.

In one embodiment, the user performs an acceptance workflow to confirm the services into the server for management. This user interaction is optional and can be automated with an auto-acceptance behavior based on a configured policy at the server.

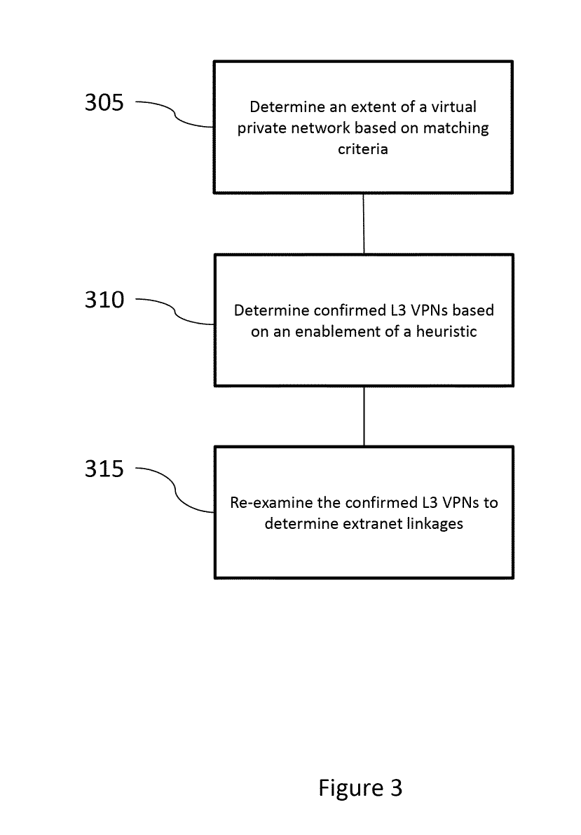

FIG. 3 illustrates a method for discovering virtual private networks with extranet configurations. At block 305, an extent of a virtual private network is determined based on a matching criteria. At block 310, confirmed L3 VPNs are determined based on an enablement of a heuristic. At block 315, the confirmed L3 VPNs are re-examined to determine extranet linkages.

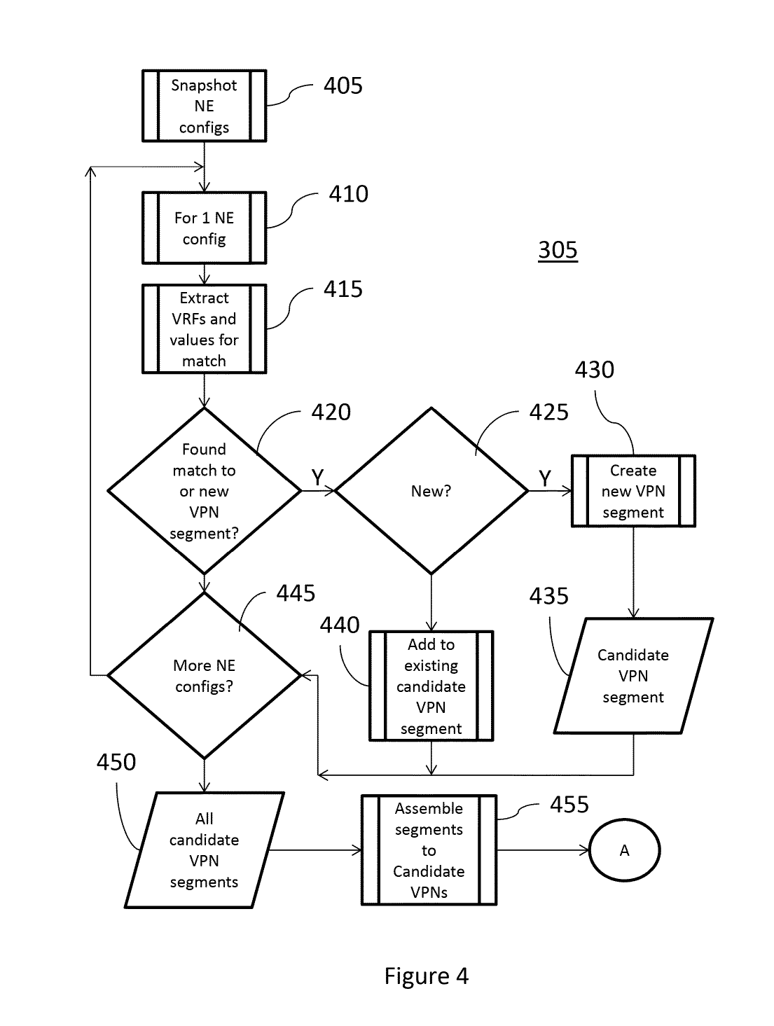

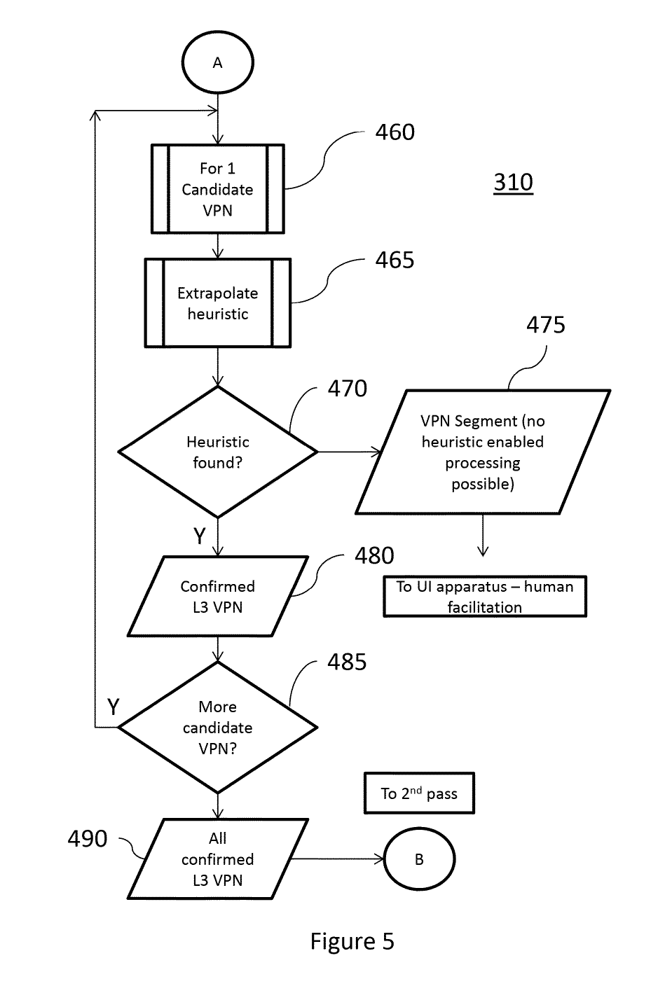

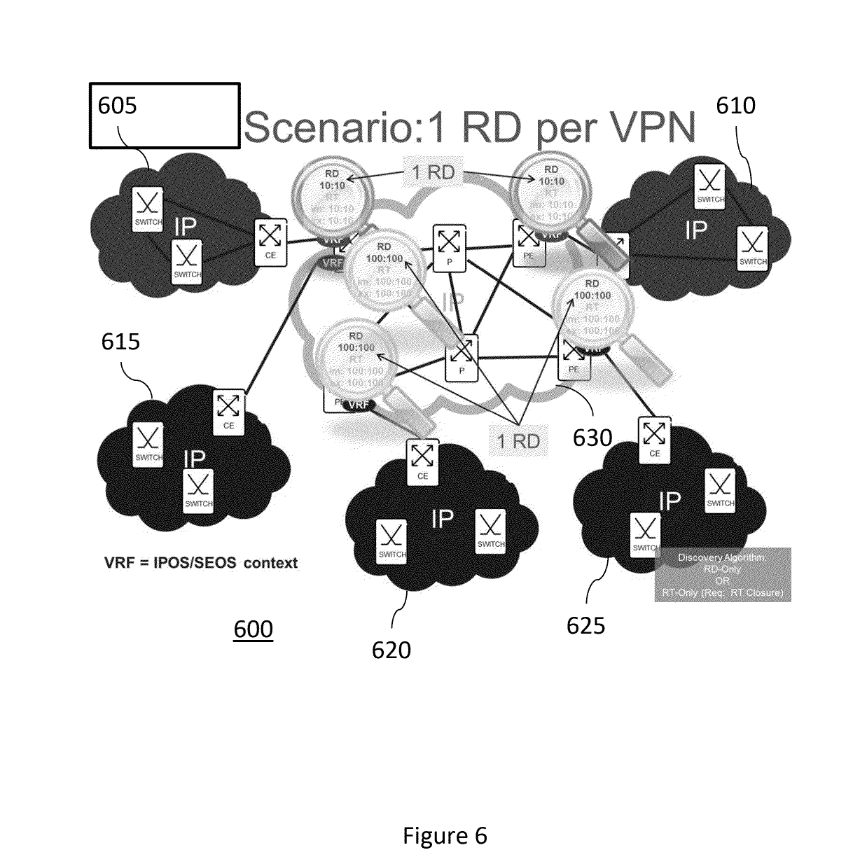

FIG. 4 and FIG. 5 illustrate a block diagram of a method 305, 310 for performing network discovery, according to one embodiment. FIG. 4 and FIG. 5 illustrate a first pass to find the extents of an individual VPN (per customer of the service provider) based on a matching criteria using route target (RT) value(s) extracted from each Virtual Routing and Forwarding (VRF) table. Services whose VPN extents can be reliably determined continue with a 2nd pass treatment—to locate extranet linkages among them. This second pass treatment is disclosed in FIG. 6. Those services whose VPN extents cannot be reliably determined will necessarily require human intervention via the UI apparatus, e.g., user interface 105.

Whether or not a VPN's extents can be reliably determined depends on the heuristic used. Two heuristics are expected to be 100% reliable. The first heuristic involves using 1 route distinguisher (RD) per service and the same RD value must also assigned as the single RT in all VRFs of the service. The second heuristic involves the using route targets (RTs) only. Both heuristics can be easily implemented in actual customer deployments. The first heuristic involves using one RD per VPN, where RD is equal to RT (1-RD-per-VPN with RD=RT). The first heuristic can be easily determined because RD=RT and the value is the same on all VRFs. Hence, the first heuristic is algorithmically unambiguous. Because the value allocated to a RT or a RD is a scarce one (based on Autonomous System prefixes that are allocated to all service providers by the IETF), the service provider will want to allocate the minimum per customer L3 VPN. In this case exactly one value is used. Please note, while the value for import RT or export RT can be one or more values, the RD is a single-valued quantity. Therefore, it follows that this heuristic must have the number of values equal to one in the import RT or export RT.

The second heuristic involves setting the import RT equal to the export RT on all VRFs of the same service (import RT=export RT on all VRFs). Operating using the second heuristic is also known as fullmesh. The second heuristic is also algorithmically unambiguous. In this case, the values listed in the import RT or the export RT are identical to each other (order of the values in the list ignored). Note RD value plays no role in the heuristic. A fullmesh RT configured service is also quite common in service provider environments because this heuristic allows for distribution of routes to all VRFs from all other VRFs.

The heuristic of 1-RD-per-VPN can also be reliable if the service provider uses exclusively this RD allocation strategy in the entire service provider (SP) network. However, this operational scenario is unlikely. The 1-RD-per-PE is not reliable as a heuristic, and is listed for comparison. The 1-RD-per-PE is not a reliable heuristic because if every RD value is different in the same service (e.g., a service discoverable by aspects of the present disclosure), it would be difficult to determine which groups of RDs should go together. As such, the 1-RD-per-PE heuristic is fundamentally ambiguous and should not be used.

The 1-RD-per-PE heuristic can be used, however, if the service provider has implemented a naming/formatting convention in the RD value's forming. For example, consider the following addresses:

10.192.1.1:10

10.192.1.1:11

10.192.1.1:12

The above addresses all have different RD values but they are the ‘same’ in the IP Address part. In this embodiment, a third (or more) pass that provides additional-value-processing such as a heuristic based on a naming/formatting convention that can be input by the service provider can be used. Other service provider policies or conventions can be effectively exploited as additional heuristics.

FIG. 6 illustrates a 1-RD-per-VPN scenario according to one embodiment. FIG. 6 shows a network 600 that includes customer networks 605, 610, 615, 620, 625 and a provider network 630. Provider network 630 includes a plurality of network elements/routers. These routers can be intermediate (P) or provider edge (PE) routers. The customer networks 605, 610, 615, 620, 625 each have at least one switch and a customer edge (CE) router that is capable of sending/receiving traffic to/from a PE router of the provider network 630. VRF tables are used by each PE router to route traffic for each customer through the provider network 630. In this scenario, customer networks 605, 610 represent a network of a first customer while customer networks 615, 620, 625 represent a network of a second customer. In this scenario, each customer is assigned one RD, e.g., 10:10 for the first customer and 100:100 for the second customer. For each customer, the import and export RT values are equal to the corresponding RD value.

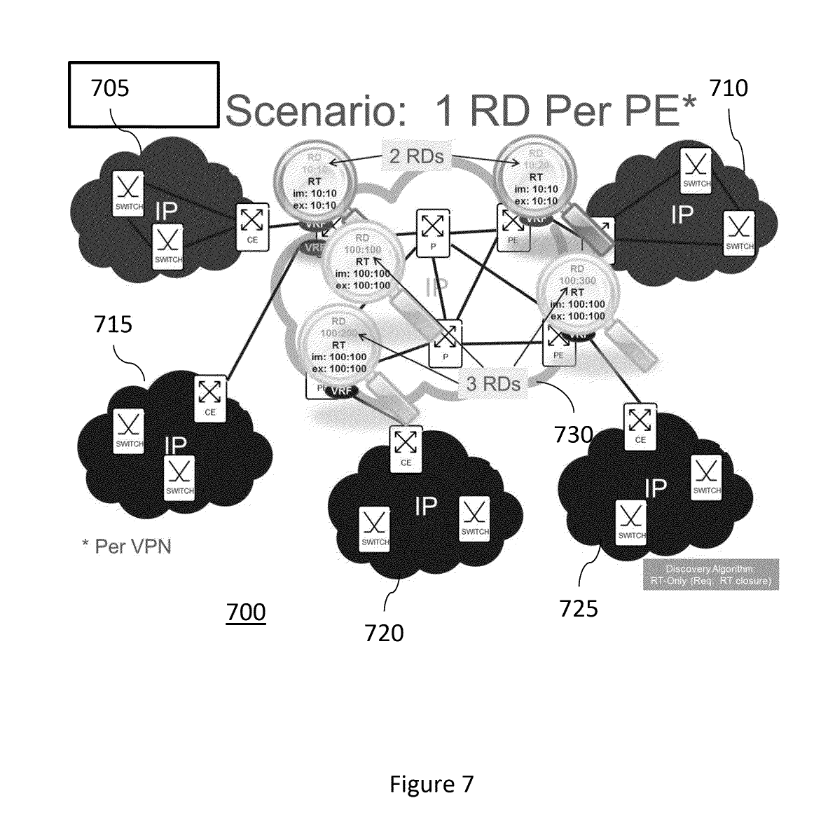

FIG. 7 illustrates a 1-RD-per-PE scenario according to one embodiment. FIG. 7 shows a network 700 that includes customer networks 705, 710, 715, 720, 725 and a provider network 730. Provider network 730 includes a plurality of network elements/routers. These routers can be P routers or PE routers. The customer networks 705, 710, 715, 720, 725 each have at least one switch and a CE router that is capable of sending/receiving traffic to/from a PE router of the provider network 730. VRF tables are used by each PE router to route traffic for each customer through the provider network 730. In this scenario, customer networks 705, 710 represent a network of a first customer while customer networks 715, 720, 725 represent a network of a second customer. In this scenario, each customer is assigned one RD per PE router, e.g., 10:10 and 10:20 for the first customer and 100:100, 100:200, and 100:300 for the second customer. The discovery algorithm for this example can be RT only, where the requirement is RT closure.

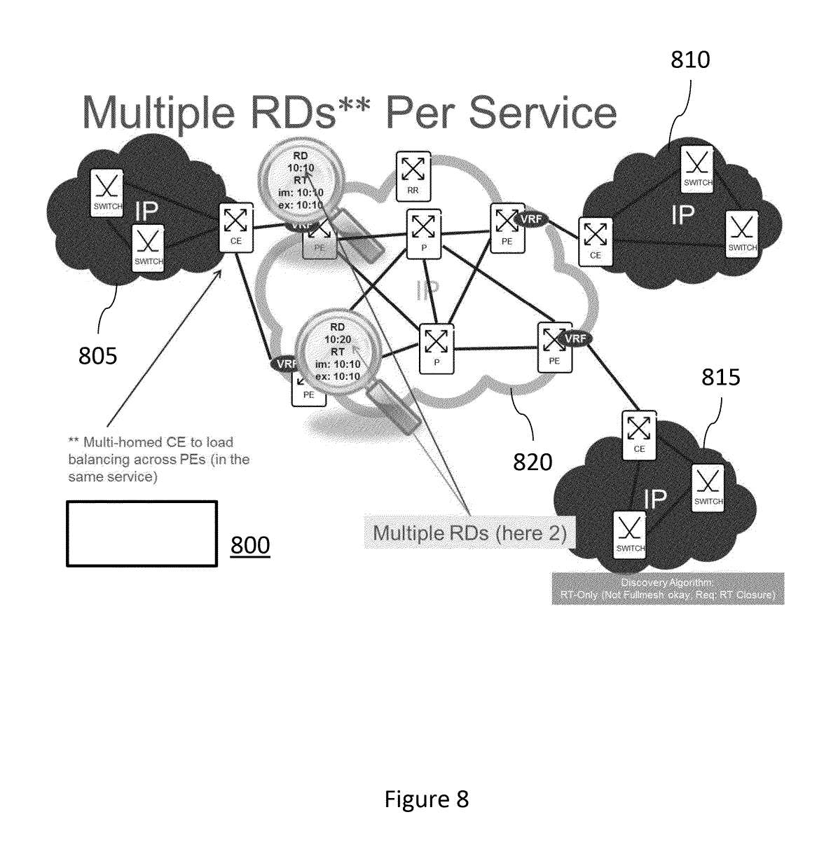

FIG. 8 illustrates a multiple RD per service scenario according to one embodiment. FIG. 8 shows a network 800 that includes service networks 805, 810, 815 of a customer and a provider network 820. Provider network 820 includes a plurality of network elements/routers. These routers can be P routers or PE routers. The service networks 805, 810, 815 each have at least one switch and a CE router that is capable of sending/receiving traffic to/from a PE router of the provider network 820. VRF tables are used by each PE router to route traffic for the service through the provider network 820. In this scenario, each service network can be assigned more than one RD. In this example, service network 805 is able to route traffic using to multiple PEs of the provider network 820, using RDs 10:10 and 10:20 in order to provide load balancing across PEs. The discovery algorithm for this example can be RT only, where the requirement is RT closure.

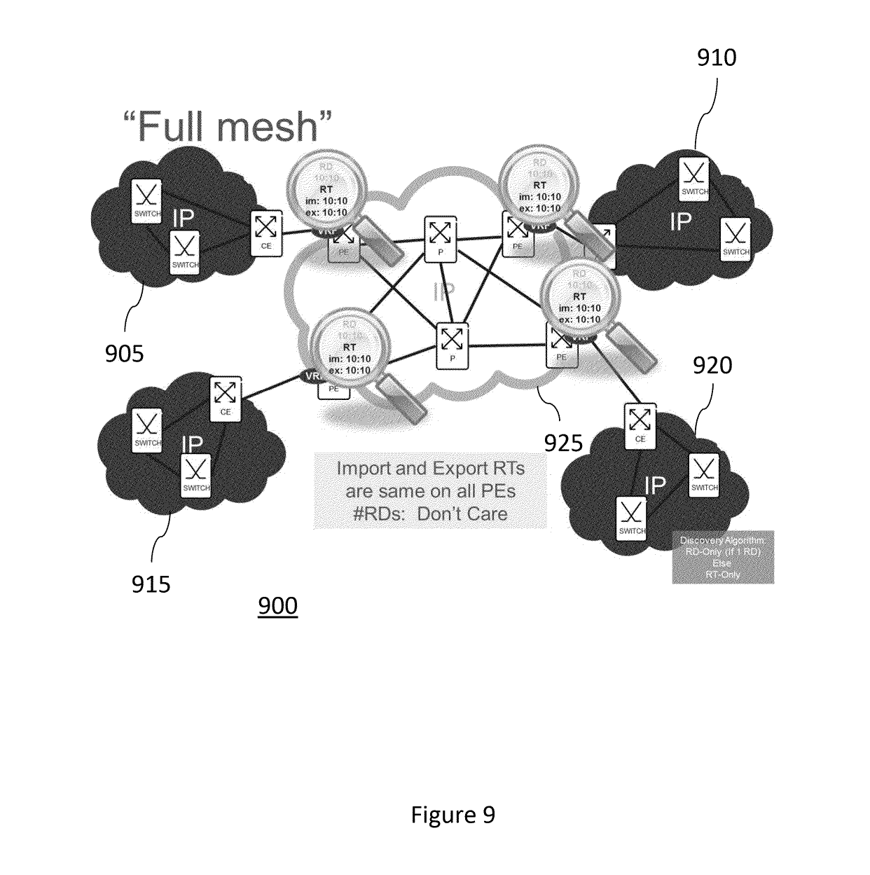

FIG. 9 illustrates a full mesh scenario according to one embodiment. FIG. 9 shows a network 900 that includes service networks 905, 910, 915, 920 of a customer and a provider network 925. Provider network 925 includes a plurality of network elements/routers. These routers can be P routers or PE routers. The service networks 905, 910, 915, 920 each have at least one switch and a CE router that is capable of sending/receiving traffic to/from a PE router of the provider network 925. VRF tables are used by each PE router to route traffic for the service through the provider network 925. In this scenario, the import RT and export RT are the same on all PEs. In this example, it does not matter how many RDs are applicable to the customer's service network. The discovery algorithm for this example can be RD only when there is just one RD or RT only.

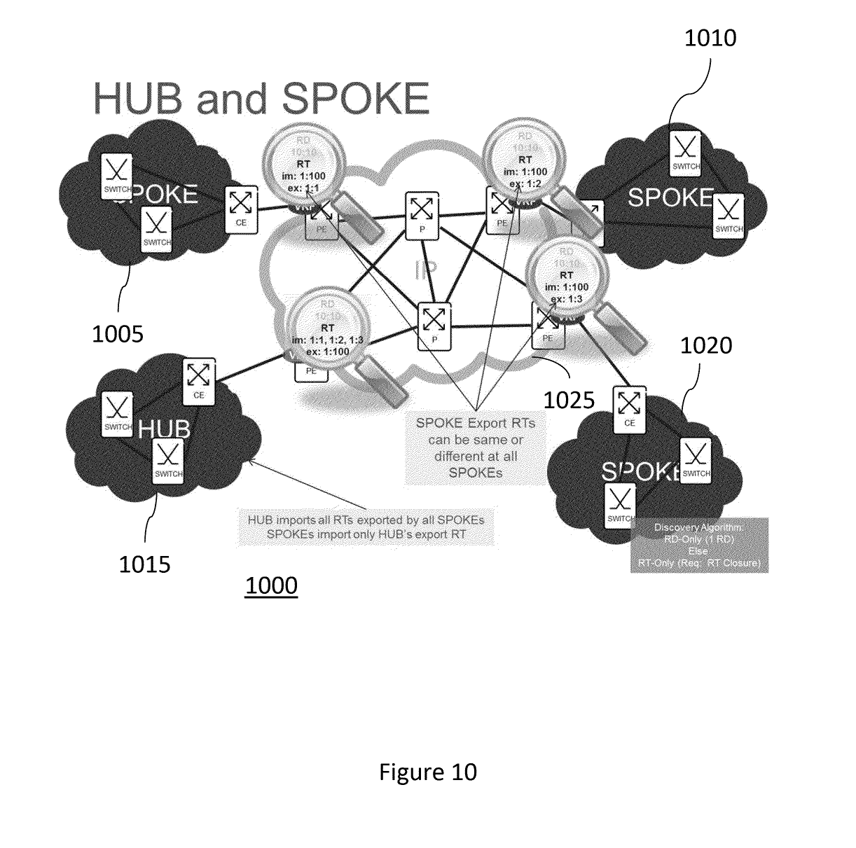

FIG. 10 illustrates a hub and spoke scenario according to one embodiment. FIG. 10 shows a network 1000 that includes service networks 1005, 1010, 1015, 1020 of a customer and a provider network 1025. Provider network 1025 includes a plurality of network elements/routers. These routers can be P routers or PE routers. The service networks 1005, 1010, 1015, 1020 each have at least one switch and a CE router that is capable of sending/receiving traffic to/from a PE router of the provider network 1025. VRF tables are used by each PE router to route traffic for the service through the provider network 1025. In this scenario network 1015 is the hub and networks 1005, 1010, 1020 are the spokes. In this example, for the hub 1015, import RT values are set to 1:1, 1:2, and 1:3 while the export RT value is 1:100. Spoke network 1005 has an import RT value of 1:100 and an export RT value of 1:1. Spoke network 1010 has an import RT value of 1:100 and an export RT value of 1:2. Spoke network 1020 has an import RT value of 1:100 and an export RT value of 1:3. The hub 1015 imports all RTs exported by all spokes 1005, 1010, 1020. The spokes 1005, 1010, 1020 import only the hub's export RT. The spoke export RTs can be the same or different at all spokes. The discovery algorithm for this example can be RD only where there is just one RD or RT only, where the requirement is RT closure.

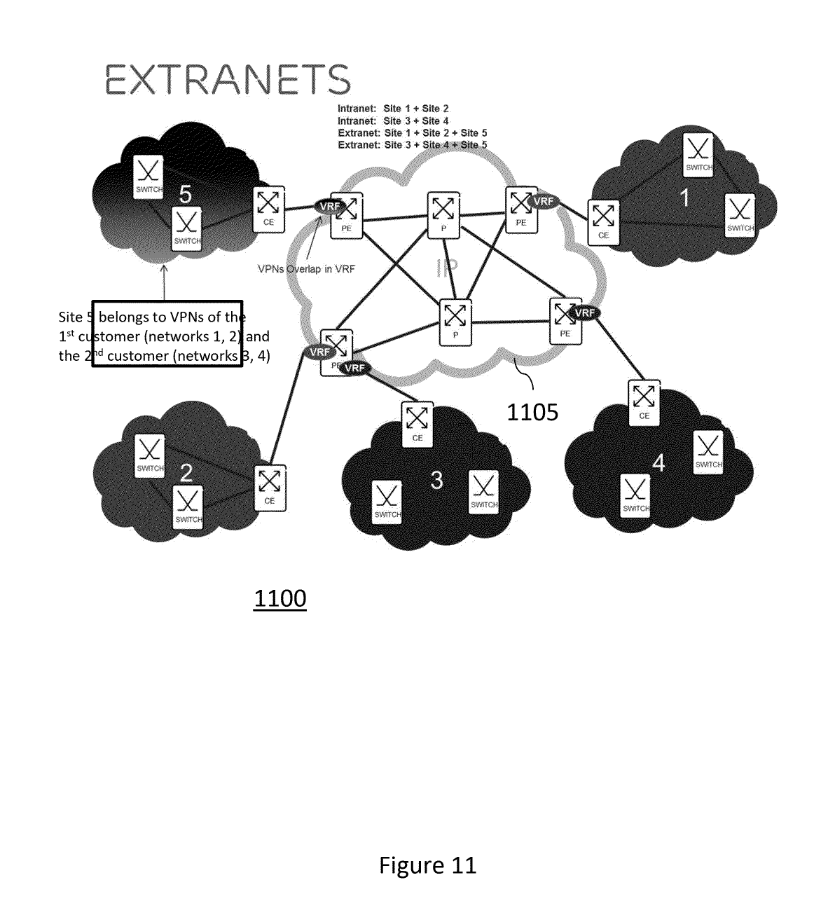

FIG. 11 illustrates an extranet scenario according to one embodiment. FIG. 11 shows a network 1100 that includes customer networks 1, 2, 3, 4, 5 and a provider network 1105. Provider network 1105 includes a plurality of network elements/routers. These routers can be P routers or PE routers. The customer networks, e.g., sites 1, 2, 3, 4, 5 each have at least one switch and a CE router that is capable of sending/receiving traffic to/from a PE router of the provider network 1105. VRF tables are used by each PE router to route traffic for each customer through the provider network 1105. In this scenario, customer networks 1, 2 represent a network of a first customer while customer networks 3, 4 represent a network of a second customer. Network 5 belongs to VPNs of the first customer and the second customer. In this scenario, a first intranet includes Site 1 and Site 2 and a second intranet includes Site 3 and Site 4. Likewise, a first extranet includes Site 1, Site 2, and Site 5 while a second extranet includes Site 3, Site 4, and Site 5.

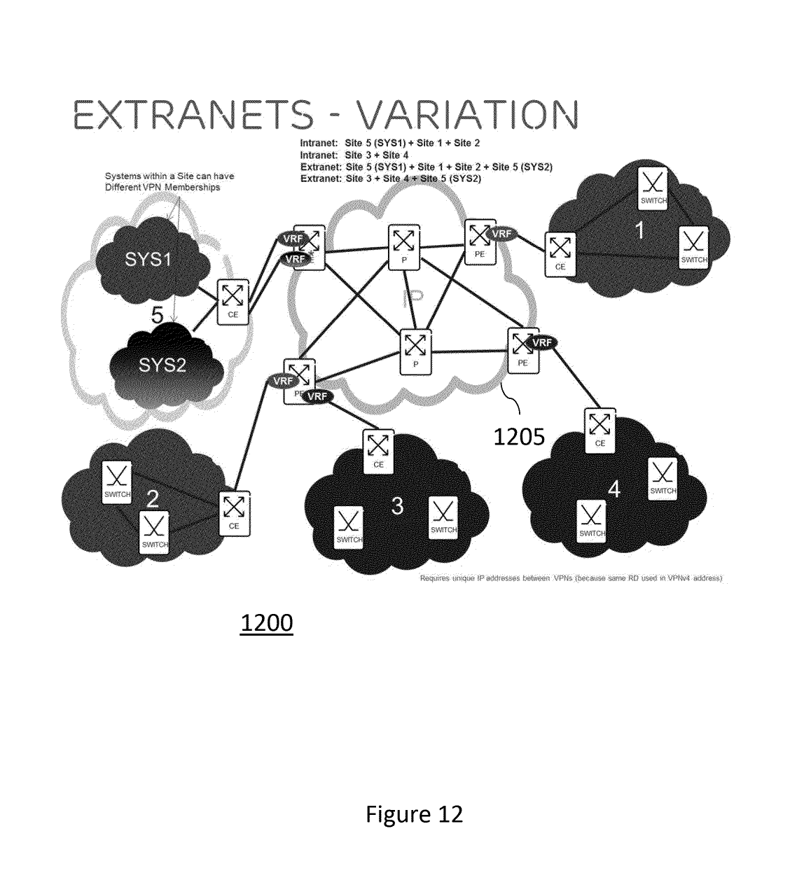

FIG. 12 illustrates an extranet scenario according to one embodiment. FIG. 12 shows a network 1200 that includes customer networks, e.g., sites 1, 2, 3, 4, 5 and a provider network 1205. Provider network 1205 includes a plurality of network elements/routers. These routers can be P routers or PE routers. The customer networks 1, 2, 3, 4, 5 each have at least one switch and a CE router that is capable of sending/receiving traffic to/from a PE router of the provider network 1205. VRF tables are used by each PE router to route traffic for each customer through the provider network 1205. Systems within a Site can have different VPN memberships. This is shown as SYS1 and SYS2 within Site 5. In this scenario, customer networks 1, 2 represent a network of a first customer while customer networks 3, 4 represent a network of a second customer. SYS1 of network 5 belongs to the VPN of the first customer. SYS2 of network 5 belongs to VPNs of the first customer and the second customer. In this scenario, a first intranet includes SYS1 of Site 5, Site 1, and Site 2 and a second intranet includes Site 3 and Site 4. Likewise, a first extranet includes Site 1, Site 2, SYS1 of Site 5, and SYS 2 of Site 5 while a second extranet includes Site 3, Site 4, and SYS2 of Site 5. This embodiment requires unique IP addresses between VPNs because the same RD is used in the network address, e.g., the VPNv4 address.

Returning to FIG. 4 and FIG. 5, these figures illustrate a method 305, 310 for performing service, e.g., L3 VPN, discovery using a first pass, according to one embodiment. At block 405, a snapshot of network element (NE) configurations is obtained. At block 410, a NE configuration is selected. At block 415, for the selected NE configuration, VRF tables and values for matching are extracted according to a match value/criteria. In one embodiment, the match value/criteria involves RT closures only, e.g., import RT, export RT. In one embodiment, the match value/criteria involves a RD match where the prerequisite is RT closure. This RT closure is guaranteed by setting RT=RD, and there is a single RD in this heuristic. In one embodiment, the match value criteria involves a VRF table name match where the prerequisite is RT closure. At block 420 a determination is made as to whether a match to a VPN segment has been found or whether a new VPN segment has been found. A matching or found segment is defined as a segment having RT closure using the second heuristic or, if the first heuristic is used, RT closure with the constraint that RT=RD. Note, any RT values that would have prevented the first heuristic's successful declaration are ignored in the first pass. These ignored RTs are potential extranet linkages that will be re-examined in the second pass.

If a new VPN segment or match has been found at block 425, a new VPN segment is created at block 430. At block 435, the RT of the new VPN segment is added to a list of candidate VPN segments. If a match to an existing VPN segment has been found at block 425, the RT of the existing VPN segment is added to an existing candidate VPN segment.

A determination is made at block 445 as to whether more NE configurations from the snapshot of NE configurations are to be evaluated. If more NE configurations are to be evaluated the method returns to block 410. If the evaluations are complete, a list of all candidate VPN segments is determined at block 450. At block 455, segments to candidate VPNs are assembled.

At block 460, a candidate VPN is selected. At block 465, a heuristic is extrapolated. The heuristic can be one of: 1 RD per PE (not reliable), 1 RD per VPN (not reliable, unless it is the only RD allocation policy exclusively employed by the service provider for its entire network), 1 RD per VPN AND RD=RT (reliable), or Fullmesh (RT=RD on all VRF tables) (reliable).

When the 1-RD-per-VPN policy is utilized, it is the only policy employed. No other policy is employed; including any policy based on RT. For example, if 1-RD-per-VPN is employed and RT closure were found among different VPNs (each with its own RD value), the RT closure must be declared a configuration error on the NE during the first pass.

Another heuristic that can be used in a first or further pass can be a heuristic based on route-maps. In one embodiment, the route-map heuristic can be used in a complementary role in a 1+pass of an N-pass algorithm where RT is the primary first pass heuristic. In this embodiment, the route-map heuristic is used to reinforce confidence that correct extranet linkages were determined.

If a heuristic is not found at block 470, it is determined at block 475 that heuristic enabled processing is not possible for the VPN segment. In one embodiment, the VPN segment can be referred to a table provided on a user interface (UI) apparatus, e.g., user interface 105, for further human facilitation.

If a heuristic is found at block 470, the candidate VPN is confirmed as a layer 3 (L3) VPN at block 480. At block 485, a check for more candidate VPNs is performed. If there are more candidate VPNs, the method returns to block 460. Once all candidate VPNs have been evaluated, a list of confirmed L3 VPNs is determined at block 490.

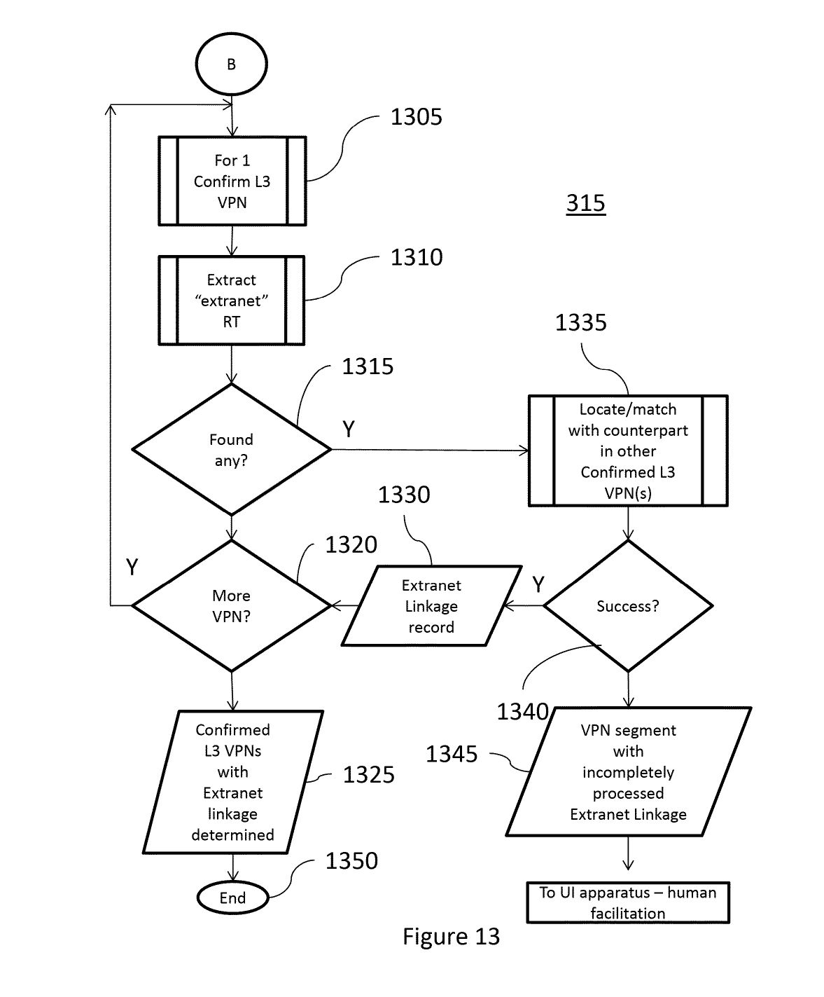

FIG. 13 illustrates a diagram of a method 315 for performing service discovery using a second pass, according to one embodiment. In the second pass, all confirmed individual VPNs' RTs are re-examined. Where RTs exist that were excluded in the heuristic's successful declaration, these previously excluded RTs indicate linkages to other confirmed individual VPNs. These linkage relationships are located among all of the VPNs and captured as service extranet linkage knowledge.

At block 1305, a confirmed L3 VPN is selected. At block 1310, an extranet RT is extracted. An extranet RT is a RT that was excluded in the earlier heuristic's declaration. An excluded extranet RT is one that was excluded based on the heuristic used, i.e., the extranet RT was excluded because, if used, it would invalidate the heuristic's determination. If extranet RTs are found at block 1315, they are located or matched with counterparts in one or more other confirmed L3 VPN(s) at block 1335.

It is possible that a confirmed individual VPN's “extranet RT” linkage actually points to a VPN service that awaits human facilitation by a user from the last pass. The confirmed VPNs with this condition will also be sent to the UI apparatus, e.g., UI 105, for human facilitation.

If the extranet RTs are not successfully located or matched, as determined at block 1340, a list of VPN segments with incompletely processed extranet linkage is determined at block 1345. In one embodiment, the VPN segment(s) can be referred to a table provided on a UI apparatus for further human facilitation to aid in the final determination of the VPNs and any extranet linkage among them.

If the extranet RTs are successfully located or matched, as determined at block 1340, the extranet RTs are added to an extranet linkage record at block 1330. If more VPNs are to be evaluated, the method returns to block 1305. Once all VPNs have been evaluated, a list of confirmed L3 VPNs with extranet linkage is determined at block 1325. The method ends at 1350.

The present disclosure discusses using heuristics to determine L3 VPNs and extranet linkages. Consider the case where there are 50 VRFs across 50 PEs, where all PEs have an RT value of 724:724. This is an unambiguous example.

Consider the case where there are 50 VRFs. In this case, 49 PEs of a service have an RT value of 724:724 and 1 PE of the service has RT values of 724:724 and 800:800. The PE having an additional RT value of 800:800 would not fit the heuristic, however, this additional value is clearly one end of an extranet linkage. In this situation, this additional VPN is ignored in order to declare success for the heuristic. If another candidate service is processed and this candidate service is found by the heuristic to have a PE with RT values of 100:100 and 800:800, the extranet linkage based on the RT value of 800:800 can be found. Each VRF has a plurality of RT values where the heuristic can be declared. RT value 100:100, in this case, would be the declared heuristic and thus, defines the extent of this VPN. RT value 800:800 was excluded to enable the declaration and, therefore, is a potential extranet linkage. RT value 800:800 would not be considered an extranet linkage if its other end is not located after user interface 105 has been exercised on it, e.g., via human facilitation.

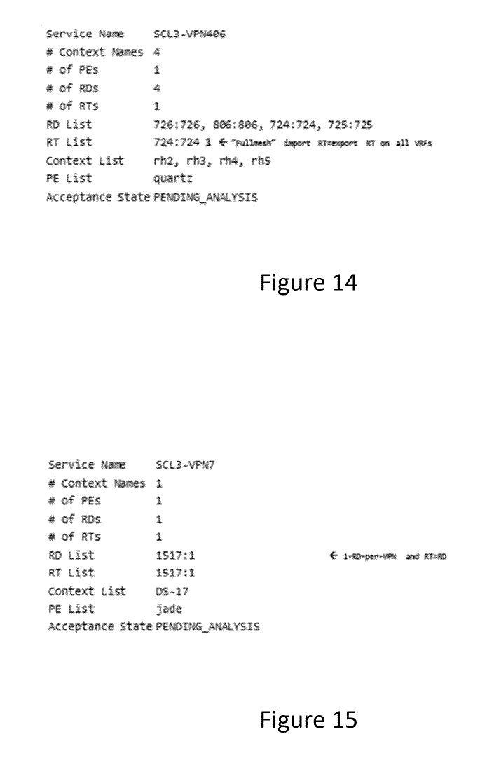

FIG. 14 and FIG. 15 illustrate example services employing heuristics described in the present disclosure. FIG. 14 shows a service having a Service Name, SCL3-VPN406. FIG. 15 shows a service having a Service Name, SCL3-VPN7. Additional parameters for the services shown in FIG. 14 and FIG. 15 are: # Context Names; # of PEs; # of RDs; # of RTs; RD List; RT List; Context List; PE List; and Acceptance State.

FIG. 14 illustrates an example service that uses the Fullmesh heuristic. In this example, the RT List shows that the import RT is equal to the export RT on all VRFs. This is denoted by 724:724 in the RT List of FIG. 14.

FIG. 15 illustrates an example service that uses the 1-RD-per-VPN with RT equal to RD heuristic. In this example, the RD List and RT List parameters both have a value of 1517:1.

As stated above, additional passes can be performed in order to further solidify or confirm results determined from earlier passes. Heuristics based on additional formatting or naming convention checks can be applied. One example of formatting for use in an additional pass can be value formats for RT and RD. Standard value formats for RT and RD are: Type 1, Type 2, and Type 3. Type 1 has a format of [4 byte: 2 byte]. Type 2 has a format of [2 byte: 4 byte]. Type 3 has a format of [4 byte: 2 byte], where the first 4 bytes are the IP address.

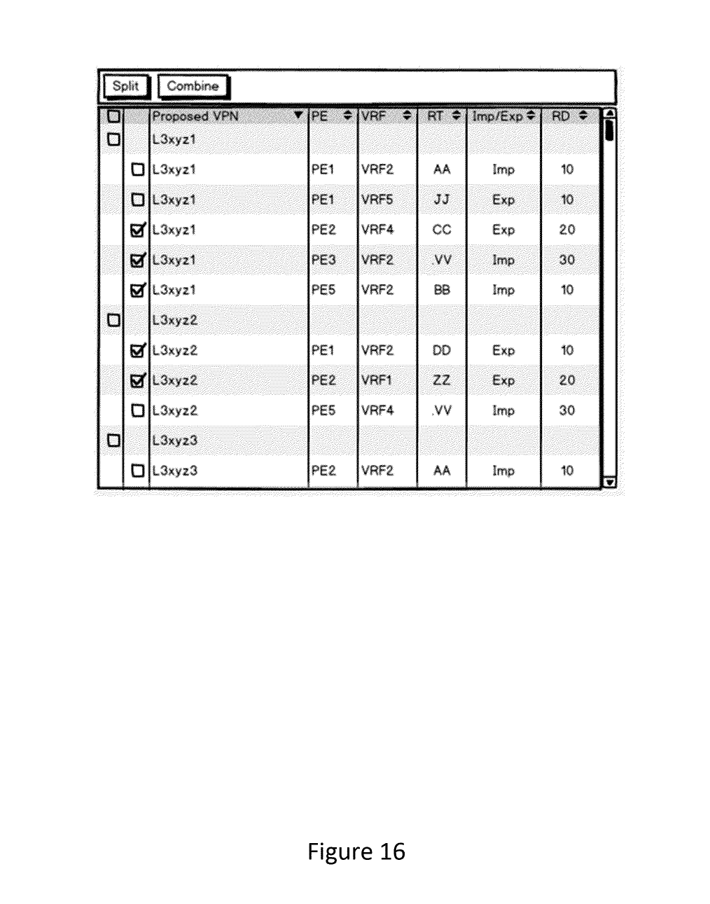

FIG. 16 illustrates a table implemented on a UI apparatus, e.g., UI device 105, that allows a human user to: 1) manually determine those VPNs whose extents cannot be reliably determined by a heuristic; and 2) manually locate extranet linkages and inject this conclusion to the system.

This manual workflow is needed only in the case where the heuristic-enabled discovery method does not apply, see FIG. 4 and FIG. 5, or FIG. 13. Given the majority use case is expected to be covered by two reliable heuristics noted earlier, manual workflow should be infrequent. Nonetheless, the manual workflow complements the heuristic-enabled method to provide a complete solution to L3 VPN Discovery where extranets are configured.

The human user of the UI apparatus will need to have per-VPN knowledge of the VPN's configuration (as they are on the NE craft) in order to facility both needs above.

For the first need above, the three key VPN attributes of RT (import and export), RD, and VRF Name, are listed in sortable columns. Thus a sort of any one of these will visually co-locate the proposed VPN segments as sequential rows. A VPN is manually defined by selecting these rows and clicking “Combine”.

Towards the 2nd need, a sort on the RT column is conducted first. Any potential extranet linkage will be immediately apparent with all RTs visually co-located. Because a linkage is always exported by one VPN and imported by another, the “Imp/Exp” column will indicate where this linkage potentially exists. The human can further confirm this identification via service provider network configuration logs or history records.

The “Split” button provides the option for the human to create N VPNs out of one VPN or VPN segment proposed. This is to recover from the scenario where the discovery method has failed to correctly identify VPNs' extents, i.e. manual fix ups.

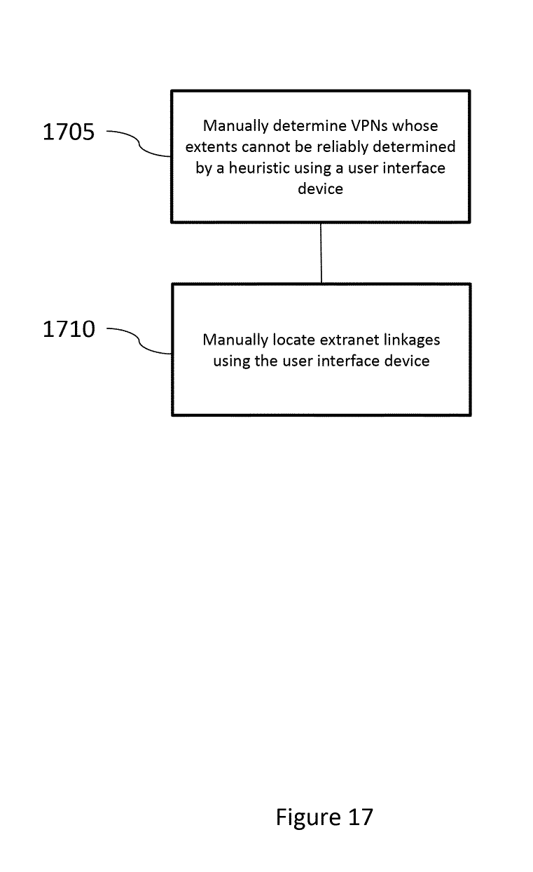

FIG. 17 illustrates a method for discovering VPNs with extranet configurations. At block 1705, VPNs whose extents cannot be reliably determined by a heuristic using a user interface device are manually determined by a user. At block 1710, extranet linkages are manually located using the user interface device.

Route target (RT), route distinguisher (RD), and virtual routing and forwarding (VRF) table name are listed in sortable columns on the user interface device. Sorting on at least one of RT, RD and VRF table name allows a user of the user interface device to visually co-locate proposed VPN segments as sequential rows. Extranet linkages can be confirmed when RTs are visually co-located. Extranet linkages can be further confirmed using service provider network configuration logs or history records.

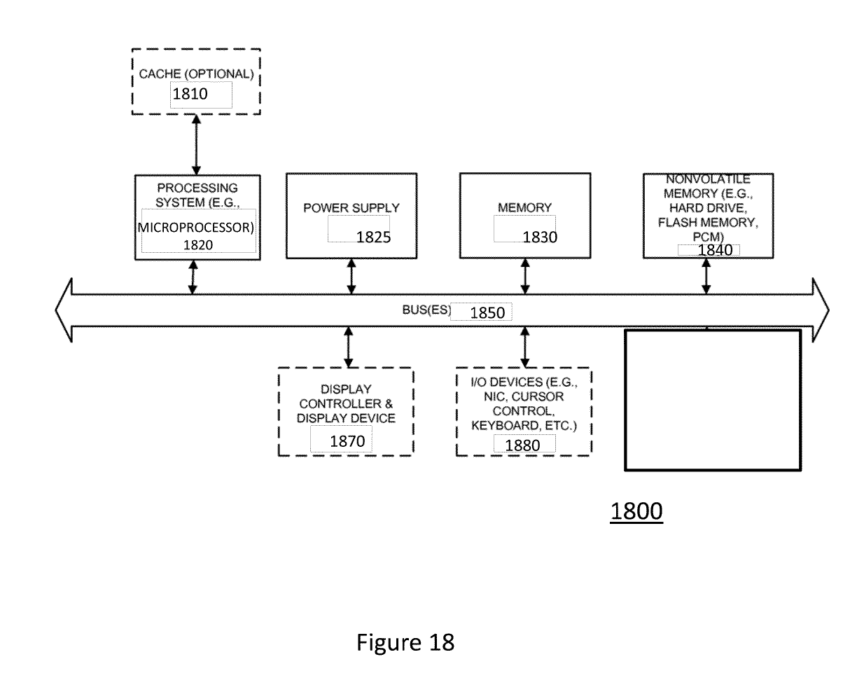

FIG. 18 illustrates a block diagram of an exemplary computer system according to one embodiment. The exemplary computer system 1800 in FIG. 18 can be used to implement user interface 105 and server 110. Those skilled in the art would recognize that other computer systems used to implement this device may have more or less components and may be used in the disclosed embodiments.

The computer system 1800 includes a bus(es) 1850 that is coupled with a processing system 1815, a power supply 1820, volatile memory 1825 (e.g., double data rate random access memory (DDR-RAM), single data rate (SDR) RAM), nonvolatile memory 1830 (e.g., hard drive, flash memory, Phase-Change Memory (PCM). The processing system 1815 may be further coupled to a processing system cache 1810. The processing system 1815 may retrieve instruction(s) from the volatile memory 1825 and/or the nonvolatile memory 1830, and execute the instruction to perform operations described above. The bus(es) 1850 couples the above components together and further couples a display controller 1870, one or more input/output devices 1880 (e.g., a network interface card, a cursor control (e.g., a mouse, trackball, touchscreen, touchpad, etc.), a keyboard, etc.). In one embodiment, the display controller 1870 is further coupled to a display device 1875.

As described herein, instructions may refer to specific configurations of hardware such as application specific integrated circuits (ASICs) configured to perform certain operations or having a predetermined functionality or software instructions stored in memory embodied in a non-transitory computer readable medium. Thus, the techniques shown in the figures can be implemented using code and data stored and executed on one or more electronic devices (e.g., an end station, a network element). Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable communication media (e.g., electrical, optical, acoustical or other form of propagated signals—such as carrier waves, infrared signals, digital signals). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more buses and bridges (also termed as bus controllers). Thus, the storage device of a given electronic device typically stores code and/or data for execution on the set of one or more processors of that electronic device. Of course, one or more parts of an embodiment of the invention may be implemented using different combinations of software, firmware, and/or hardware.

While the flow diagrams in the figures show a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described. The description is thus to be regarded as illustrative instead of limiting.

What is claimed is:

1. A method for discovering virtual private networks with extranet configurations, which comprises:
determining an extent of a virtual private network (VPN) based on matching criteria; and
determining confirmed layer three (L3) VPNs based on an enablement of a heuristic; and
re-examining the confirmed L3 VPNs to determine extranet linkages.

2. The method of claim 1, wherein extranet linkages are determined automatically when a heuristic is enabled and used.

3. The method of claim 1, wherein L3 VPNs are determined manually through a user interface when a heuristic is not enabled.

4. The method of claim 3, wherein extranet linkages are determined manually through a user interface when a heuristic is not enabled.

5. The method of claim 1, wherein the matching criteria comprises route target information.

6. The method of claim 1, wherein the matching criteria comprises route distinguisher information.

7. The method of claim 1, wherein the matching criteria comprises virtual routing and forwarding (VRF) table information.

8. A server for discovering virtual private networks with extranet configurations, comprising a processor configured to:
determine an extent of a virtual private network (VPN) based on matching criteria; and
determine confirmed layer three (L3) VPNs based on an enablement of a heuristic; and
re-examine the confirmed L3 VPNs to determine extranet linkages.

9. The server of claim 8, wherein extranet linkages are determined automatically when a heuristic is enabled and used.

10. The server of claim 8, wherein the L3 VPNs or extranet linkages are further confirmed using a second heuristic that is based on formatting.

11. The server of claim 8, wherein the L3 VPNs or extranet linkages are further confirmed using a second heuristic that is based on a naming convention.

12. The server of claim 8, wherein the matching criteria comprises route target information.

13. The server of claim 8, wherein the matching criteria comprises route distinguisher information.

14. The server of claim 8, wherein the matching criteria comprises virtual routing and forwarding (VRF) table information.

15. A method for discovering virtual private networks (VPNs) with extranet configurations, which comprises:
manually determining VPNs whose extents cannot be reliably determined by a heuristic using a user interface device; and
manually locating extranet linkages using the user interface device.

16. The method of claim 15, which further comprises listing route target (RT), route distinguisher (RD), and virtual routing and forwarding (VRF) table name in sortable columns.

17. The method of claim 16, wherein sorting on at least one of RT, RD and VRF table name allows a user of the user interface device to visually co-locate proposed VPN segments as sequential rows.

18. The method of claim 17, wherein extranet linkages are confirmed when RTs are visually co-located.

19. The method of claim 18, wherein extranet linkages are further confirmed using service provider network configuration logs or history records.

20. A user interface device for discovering virtual private networks (VPNs) with extranet configurations, comprising a processor configured to allow a user of the user interface device to:
manually determine VPNs whose extents cannot be reliably determined by a heuristic; and
manually locating extranet linkages.
